(19) United States
(12) Patent Application Publication
(10) Pub. No.: US 2009/0197025 A1
(43) Pub. Date: Aug. 6, 2009

(54) Thermal Break for Aluminum Structures

(76) Inventors: Shawn Michael Burst, Metairie, LA (US); Angelina Burst, Metairie, LA (US)

Correspondence Address: MAYBACK & HOFFMAN, P.A., 5722 S. FLAMINGO ROAD #232, FORT LAUDERDALE, FL, 33330, US

(21) Appl. No.: 12/327,546

(22) Filed: Dec. 3, 2008

Related U.S. Application Data
(60) Provisional application No. 60/992,455, filed on Dec. 5, 2007.

(51) Int. Cl. B32B 1/08; B32B 7/08; B23P 11/00

(52) U.S. Cl. 428/34.1; 428/223; 29/525.01

(57) ABSTRACT

A thermal insulating structural assembly and a method for forming a thermal insulating structural assembly includes longitudinally separating an elongated metallic support beam into a first portion and a second portion, mechanically coupling the first beam portion to the second beam portion with a plurality of clamp assemblies so that the first beam portion is spaced a predetermined non-zero distance from the second beam portion and is mechanically coupled to the second beam portion only by the clamp assemblies, and introducing between the beam portions, a low thermal-conductive material at least partially thermally insulating the first beam portion from the second beam portion.

### CROSS-REFERENCE TO RELATED APPLICATION

This application claims priority, under 35 U.S.C. § 119, of U.S. Provisional Patent Application Ser. No. 60/992,455, filed Dec. 5, 2007, the entire disclosure of which is incorporated hereby by reference in its entirety.

### FIELD OF THE INVENTION

This invention relates in general to metallic framing systems for structures, such as buildings, and more particularly, to thermal breaks in aluminum frames for thermally-insulating interior portions of a structure from exterior portions of the structure.

### BACKGROUND OF THE INVENTION

Some types of pre-fabricated residential homes use a framing system that is not of traditional wood and nails, but, rather, is made of high-grade aluminum “profiles,” such as the profile 100 shown in FIG. 1. These “profiles” are used as the beams and columns and, when linked together, a skeleton of profiles 100 provides support for the building structure.

More specifically, the profile 100 shown in FIG. 1 is an extruded aluminum member. The profiles 100 are locked in place and held together using stainless steel or other types of bushings and connectors, which are not shown in FIG. 1.

The exemplary profile 100 shown in FIG. 1 includes a pair of T-shaped slots 102 on its exterior. Once the structure is erected so that the profiles provide a frame structure, pairs of T-slots 102 in parallel adjacent profiles 100 face each other in an opposing configuration. Pre-cut panels of wood, stone, metal, and others are slid into and secured in place by the opposing T-slots 102.

A major problem with metallic-framework structures is thermal insulation. Throughout much of the year, depending on the geographic location, it is desirable for the interior of a structure to remain at a temperature that is different from the exterior of the building. For instance, in the winter, when the exterior of the building is cold, it is desirable for the interior to be warmer than the exterior, sometimes significantly, and vice versa in the summer.

However, because metal is among the best materials known for temperature conduction, the profiles 100 disadvantageously create a thermal bridge between the exterior and interior of the structure and external temperatures are rapidly and undesirably communicated to the interior of the structure.

Two known insulation systems for extruded construction members are known as a “thermal strut,” shown in FIG. 2, and a “pour-and-debridge” system, shown in FIG. 3. The thermal strut, shown in FIG. 2, is designed to accept the ends of an insulbar strip 202. The extruded cavity 204 is roughed up before the Insulbar 202 is inserted, usually manually, between opposing walls 206 and 208 defining the cavity 204. The walls 206 and 208 are then “rolled” or otherwise crimped to hold the Insulbar 202 in place.

In order to crimp the walls 206 and 208 from both sides, access is required from both sides of the walls. Due to the need for structural strength to accomplish the. crimp, crimping is difficult and not desirable. Naturally the extrusion can be designed in such a way as to make the accessible leg thinner and more receptive to mechanical deformation. However, post-processing in general is disadvantageous and should be avoided as much as possible.

For the pour-and-debridge system, as shown in FIG. 3, a resin 300 is poured into a cavity 302 that has been extruded into the aluminum profile 300. Once cured, a section 304 of the aluminum base 306 is milled away creating two completely separate sections 308 and 310 with the resin 300 being the only connecting element. The resin 300 air-cures very quickly (in minutes) and requires no special equipment.

The disadvantage of the pour-and-debridge system is that the two thermally separated sections 308 and 310 start as a single extrusion. This decreases the flexibility and increases costs due to the increased number of sections required Also, the pour-and-debridge system requires a difficult and expensive post-processing milling step to create the gap 304.

Therefore, a need exists to overcome the problems with the prior art as discussed above.

### SUMMARY OF THE INVENTION

The present invention, according to an embodiment, provides an insulating component between aluminum structural profiles held together by clamps to prevent thermal conductivity.

The invention provides a thermal insulating structural assembly that overcomes the hereinafore-mentioned disadvantages of the heretofore-known devices and methods of this general type and that provides structural support to a building, while simultaneously providing a thermal break between an interior and exterior of the building.

With the foregoing and other objects in view, there is provided, in accordance with the invention, a thermal insulating structural assembly that includes a first and a second clamp assembly, a first metallic beam, a second metallic beam mechanically coupled to the first metallic beam by the first and second clamp assemblies so that the first metallic beam is spaced a predetermined non-zero distance from the second metallic beam, and a low thermal-conductive material provided between the first metallic beam and the second metallic beam, the material at least partially thermally insulating the first metallic beam from the second metallic beam.

In accordance with another feature of the invention, each of the first and second clamp assemblies include a first beam coupling portion, a second beam coupling portion opposing the first beam coupling portion, and a coupling portion connecting member mechanically coupling the first beam coupling portion to the second beam coupling portion.

In accordance with a further feature of the invention, each of the coupling portions include a pair of substantially parallel beam engaging areas spaced a predetermined non-zero distance from one another.

In accordance with an added feature of the invention, a first low-thermally conducting strip bridges the predetermined distance between the beams and defines a structural-assembly interior therein.

In accordance with an additional mode of the invention, there is provided a method for forming a thermal insulating structural assembly, where the method includes the steps of mechanically coupling a first metallic beam to a second metallic beam with a plurality of clamp assemblies so that the first metallic beam is spaced a predetermined non-zero distance from the second metallic beam and mechanically coupled only by the clamp assemblies and introducing between the beams, a low thermal-conductive material at least partially thermally insulating the first metallic beam from the second metallic beam.

In accordance with yet another mode, the invention includes the step of supporting a structure with the thermal insulating structural assembly so that the first metallic beam is facing an interior of the structure and the second metallic beam is facing an exterior of the building, thereby thermally insulating the interior from the exterior.

In accordance with yet a further mode of the invention, a pair of spacers is inserted between the beams prior to the introducing step, the spacers bridging the non-zero distance and defining a structural-assembly interior therein.

In accordance with yet a further mode, the invention includes a method for forming a thermal insulating structural assembly, where the method includes the steps of longitudinally separating an elongated metallic support beam into a first portion and a second portion, mechanically coupling the first beam portion to the second beam portion with a plurality of clamp assemblies so that the first beam portion is spaced a predetermined non-zero distance from the second beam portion and mechanically coupled to the second beam portion only by the clamp assemblies, and introducing between the beam portions, a low thermal-conductive material at least partially thermally insulating the first beam portion from the second beam portion.

Although the invention is illustrated and described herein as embodied in a thermal break for aluminum structures, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the aluminum profile.

### BRIEF DESCRIPTION OF THE DRAWINGS

The accompanying figures, where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a fragmentary, perspective view of a prior-art framing system.

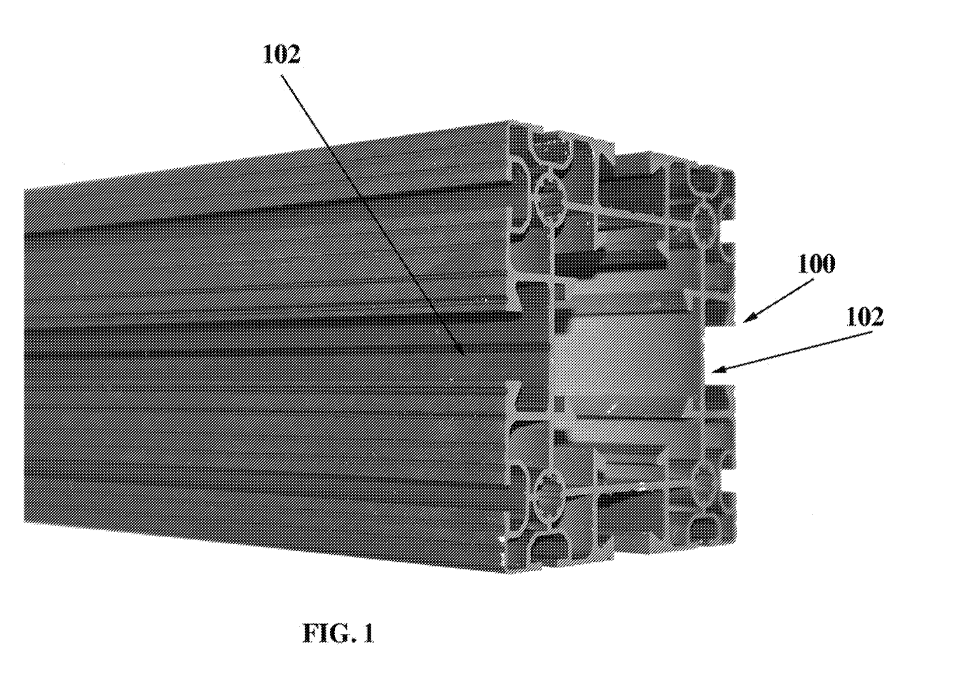

FIG. 2 is a fragmentary, perspective view of another prior-art framing system.

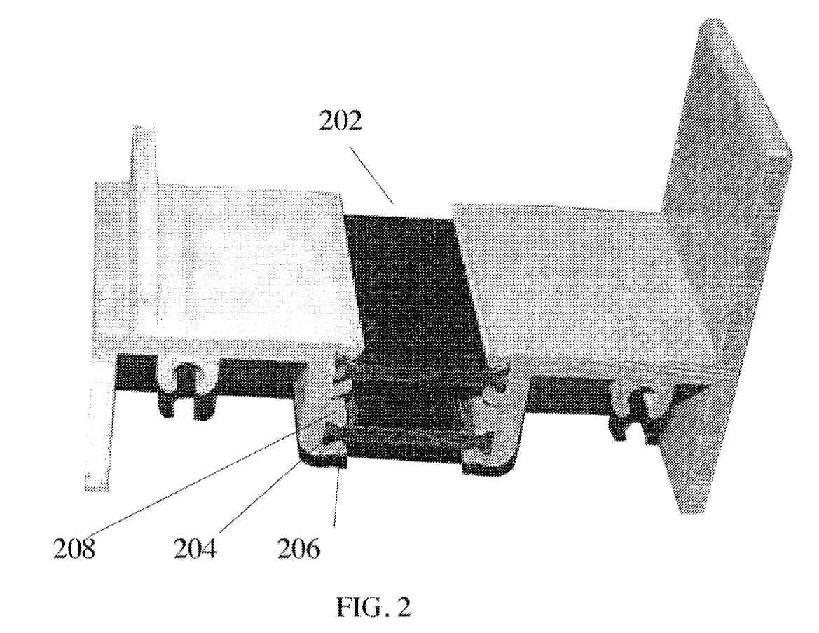

FIG. 3 is a fragmentary, perspective view of still another prior-art framing system.

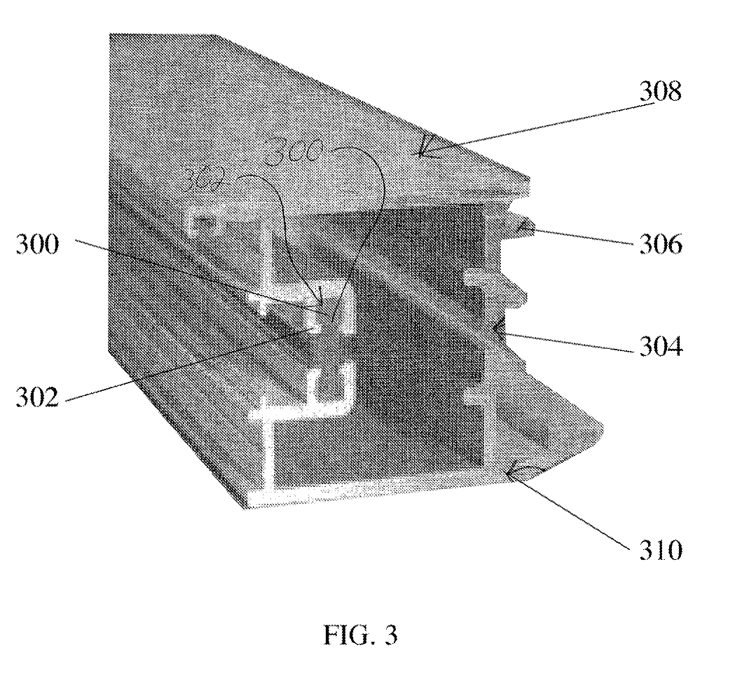

FIG. 4 is an elevational view of one end of a thermally-insulating beam-coupling assembly according to an exemplary embodiment of the present invention.

FIG. 5 is a perspective exploded view of the thermally-insulating beam-coupling assembly of FIG. 4.

FIG. 6 is an elevational exploded view of the thermally-insulating beam-coupling assembly of FIG. 4.

FIG. 7 is a fragmentary, perspective view of non-aligned components of the thermally-insulating beam-coupling assembly of FIG. 4.

FIG. 8 is an elevational view of one end of another thermally-insulating non-uniform-beam-coupling assembly according to an exemplary embodiment of the present invention.

FIG. 9 is a fragmentary, perspective view of non-aligned components of the thermally-insulating non-uniform-beam-coupling assembly of FIG. 8.

FIG. 10 is an exploded perspective view of the components of the thermally-insulating non-uniform-beam-coupling assembly of FIG. 8.

FIG. 11 is an elevational view of an end of another thermally-insulating non-uniform-beam-coupling assembly according to an exemplary embodiment of the present invention.

FIG. 12 is an elevational view of the thermally-insulating non-uniform-beam-coupling assembly of FIG. 11 with the insulating foam removed to show cross-clamping assemblies according to an exemplary embodiment of the present invention.

FIG. 13 is an exploded elevational view of the components of the thermally-insulating non-uniform-beam-coupling assembly of FIG. 11.

FIG. 14 is an exploded elevational view of the components of the thermally-insulating non-uniform-beam-coupling assembly of FIG. 11.

FIG. 15 is a non-aligned perspective view of the components of the thermally-insulating non-uniform-beam-coupling assembly of FIG. 11.

FIG. 16 is an exemplary process flow diagram of a method for forming a thermal insulating structural assembly according to an exemplary embodiment of the present invention.

### DETAILED DESCRIPTION

Herein various embodiment of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

The present invention advantageously provides the ability to utilize metallic structural (load bearing) beams while separating climate-controlled interior spaces from the external elements and vice versa. According to an embodiment, the invention includes an assembly and method of assembly that includes clamping two or more beams together and then sliding a plastic strips in place between the beams, creating a sealed space. The beams are then laid on a surface with the installed plastic strip facing down. Expanding foam insulation is injected into the center void and a top plastic strip is slid between the beams on a side opposite the first plastic strip to provide a superior thermal-insulating structurally-supporting assembly.

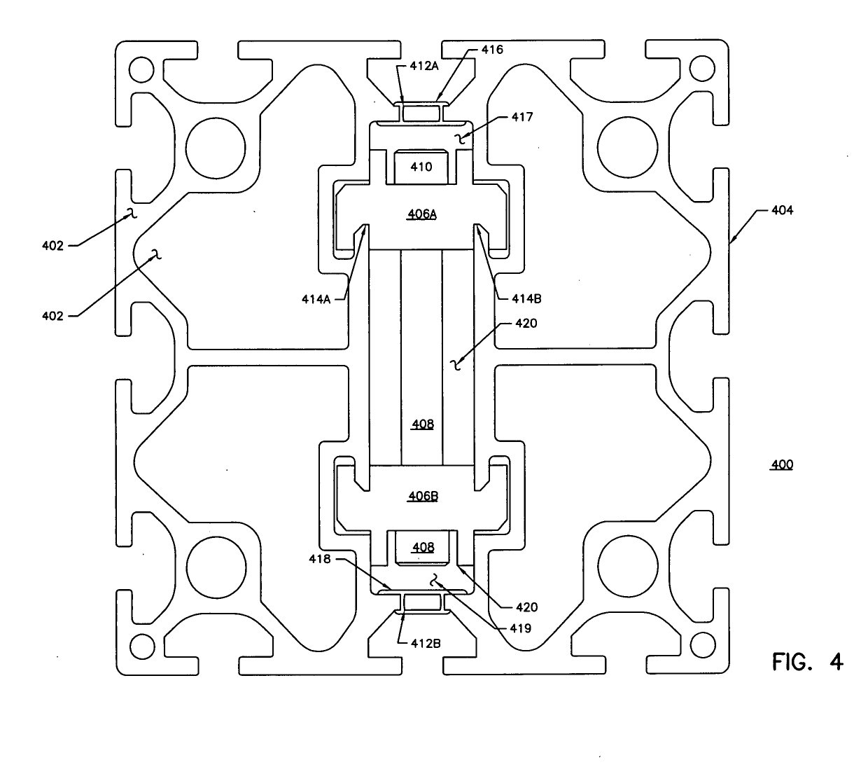

Specifically, referring to the figures of the drawings in detail and first, particularly to FIG. 4 thereof, there is shown two opposing metallic beams 402 and 404. The beams 402 and 404 can be, for instance, aluminum or any other metallic material and are generally formed by an extrusion process. As is shown in FIG. 4, the beams 402 and 404 have large cavities 422 that run longitudinally along the length of each beam (into the plane of the drawing). Providing these cavities results in a savings in materials and a much lighter beam weight than if the beam were solid metal. In the embodiment shown in FIG. 4, the beams are mirror symmetrical; however, symmetry is not necessary and, as will be shown below, is advantageously not present in some embodiments.

It can also be seen in FIG. 4 that the beams 402 and 404 are joined by a steel “clamp” assembly 420. The clamp assembly 420 can be any structure that couples the first beam 402 to the second beam 404 and can be any material, shape, and size. The clamp assembly 420 shown in FIG. 4 is merely exemplary of one configuration of a clamp assembly that works to hold the beams securely in the relationship shown.

The clamp assembly 420 includes a first beam coupling portion 406a, a second beam coupling portion 406b opposing the first beam coupling portion, and a coupling portion connecting member 408 mechanically coupling the first beam coupling portion 406a to the second beam coupling portion 406b.

For installation, the clamp assemblies 420 can be loosely preassembled and then slid inside and down the length of the beams 402, 404 to an interior portion of the beams 402, 404 from one end thereof. The coupling portion connecting member 408 of the clamp assemblies 420 can be a commercially available screw or bolt. The coupling portion connecting member 408 can be attached to the first or second beam coupling portions 406a, 406b with a hex or other type of nut 410. The beam coupling portions 406a, 406b can also be joined by any other measures for coupling two elements to each other.

Each of the beam coupling portions 406a, 406b is provided with a pair of substantially parallel beam engaging areas 414a and 414b spaced at a predetermined non-zero distance from one another. Once the two beams 402 and 404 to be joined are aligned, i.e., squared or the ends flush with each other, if desired, the member 408 is tightened. As the member 408 is tightened, the beam coupling portions 406a, 406b grasp the beams 402 and 404 and tightly secure or couple the beams at a fixed distance from each other. This clamp assembly 420 ensures maintenance of the proper distance and alignment between the beams 402 and 404. No other hardware is necessary to ensure proper coupling, rigidity, and strength. The clamping assembly 420 effectively creates a single beam that includes both beams 402 and 404 rigidly held together.

Advantageously, the only point of physical contact between the two beams 402 and 404 is the clamp assembly 420. The area of thermal conduction between the beams 402 and 404 has, therefore, been greatly reduced. The reduction in thermal conduction area, in turn, helps insulate each of the extrusions from one another.

After the beams 402 and 404 are affixed to each other, a pair of low-thermally conducting strips 412a and 412b are inserted between and bridges the gap between the beams 402 and 404, in a configuration, as shown, for example, in FIG. 4. Each of the strips 412a and 412b define and seal off a respective gap 416 and 418. As will be explained below, the sealed off gaps 416 and 418 create interior spaces 417 and 419, respectively, defined by the strips 412a and 412b, also respectively, and can be filled with a temperature-insulating material. The interior spaces 417 and 419 are only separated by the clamp assembly 420 and merge into a single void throughout most of the length of the beam assembly 400. In one embodiment, the strips 412a and 412b are made of plastic. However, the strips are not limited to plastic and can be any other thermally-insulating or non- or low-thermal conducting material.

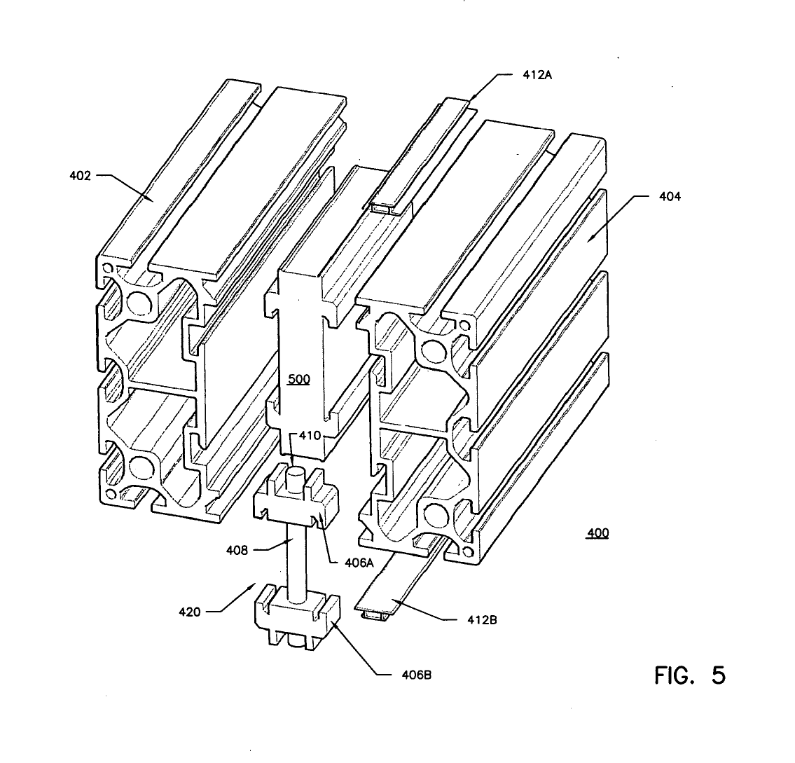

FIG. 5 is an exploded perspective view of the same beam assembly 400, which includes the first beam 402, the second beam 404, the clamp assembly 420, and the strips 412a and 412b. When assembled, the gaps 416 and 418 are bridged with the plastic strips 412a and 412b which complete the “T” shape of the T-slot while, at the same time, closing the void(s) 417 and 419 between the beams. After assembly, the void(s) 417 and 419 can be filled with foam insulation 500, for example. There are many commercially available foam materials that can be used to fill the voids 417 and 419. In one embodiment, the foam 500 is a non- or low-temperature-conducting material and is sprayed or otherwise introduced into the void(s) 417 and 419, where it then cures and hardens. The expanding foam will fill all crevices while the plastic strips 412a and 412b prevent the foam 500 from exiting the void(s) 417 and 419 before the foam hardens. Naturally, any type of insulation material could be used including stuffing the void(s) 417 and 419 with standard (pink) fiber glass wall insulating material.

Because the clamp assembly 420 is the only metallic contact areas between the exterior and interior of the beams, thermal conductivity is minimized greatly. As an example, 4-5 sets of clamp assemblies 420 can be used for each 8′-10′ beam. Enveloping the clamps in insulating foam 500 thus effectively “purges” the void of hot or cold air.

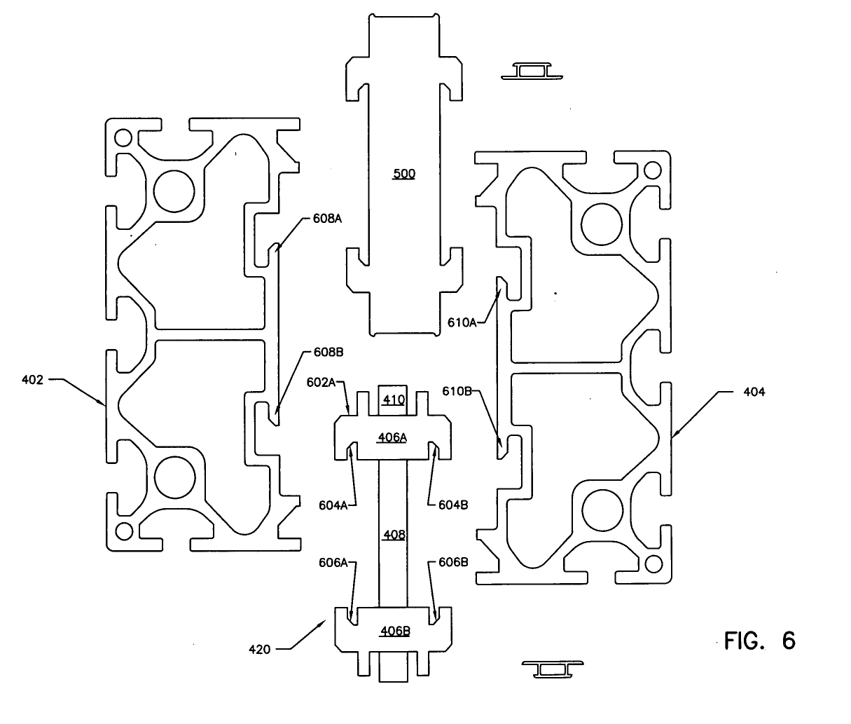

Referring now to FIG. 6, a set of “tabs” 602a and 602b, which extend from each of the beam coupling portions 406a and 406b of the clamp assembly 420 towards the outer surfaces of tile beams 402 and 404, help maintain the desired spacing between the beams 402 and 404. These tabs 602a and 602b are also spaced away from each other a distance that is just slightly greater than the width of the hex nut 410 located between them. The spacing keeps the nut 410 (which the coupling portion connecting member 408 engages) from turning while tightening the coupling portion connecting member 408. This provides a distinct advantage in ease of assembly, and the resulting ability to effectively construct a beam on-site (if necessary).

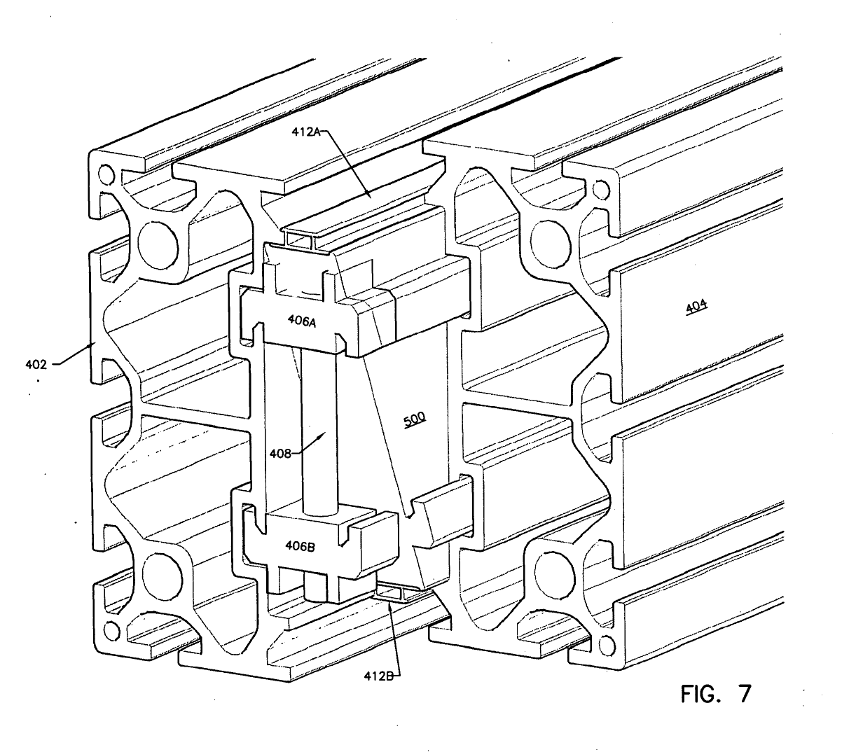

Additionally, as was explained above, the substantially parallel beam engaging areas 604a, 604b, 606a, and 606b, embodied here as angled mating surfaces, of the beam coupling portions 406a and 406b help properly align the beam coupling portions 406a and 406b with angled portions 608a, 608b, 610a, and 610b of the beams 402 and 404 when the coupling portion connecting member 408 is tightened. FIG. 7 shows an assembled, but unaligned view of the thermal insulating structural assembly of the present invention (unaligned meaning that the components in FIG. 7 are displaced from one another longitudinally for ease of understanding).

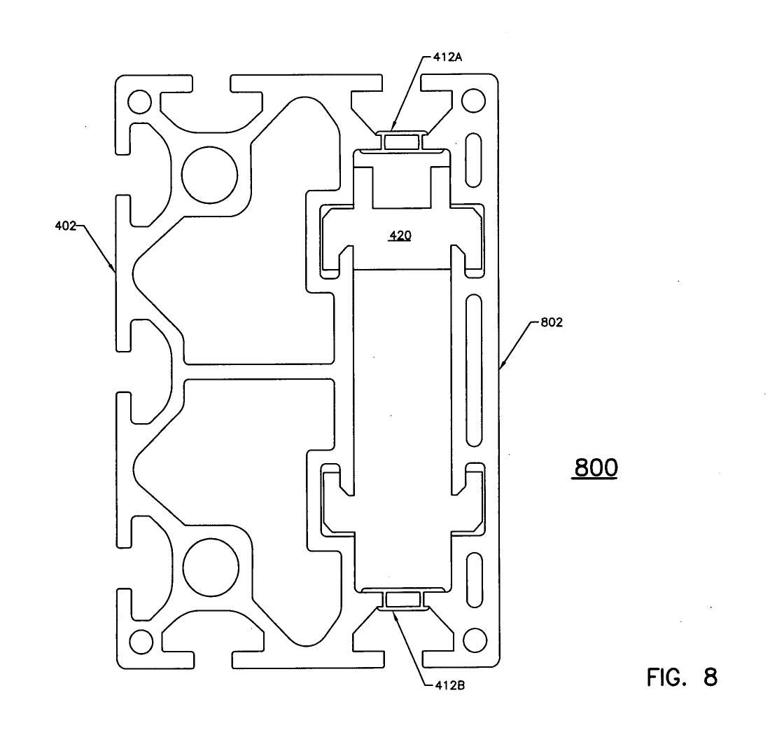

The present invention provides the advantage that beams of varying sizes, dimensions, and designs can be used and assembled. FIG. 8 shows an example of a relatively thin beam 802 coupled through the clamp assembly 420 to the relatively thicker first beam 402. The new beam 802 is clearly of a different size than the beam 404 that has thus far been described and shown as being coupled to beam 402. Beams of varying sizes may be necessary or desirable in certain circumstances. The width of the beam is determined by the load that beam will be responsible for. Non-load bearing walls or beams would allow use of a lower-strength beam and, therefore, a different width beam.

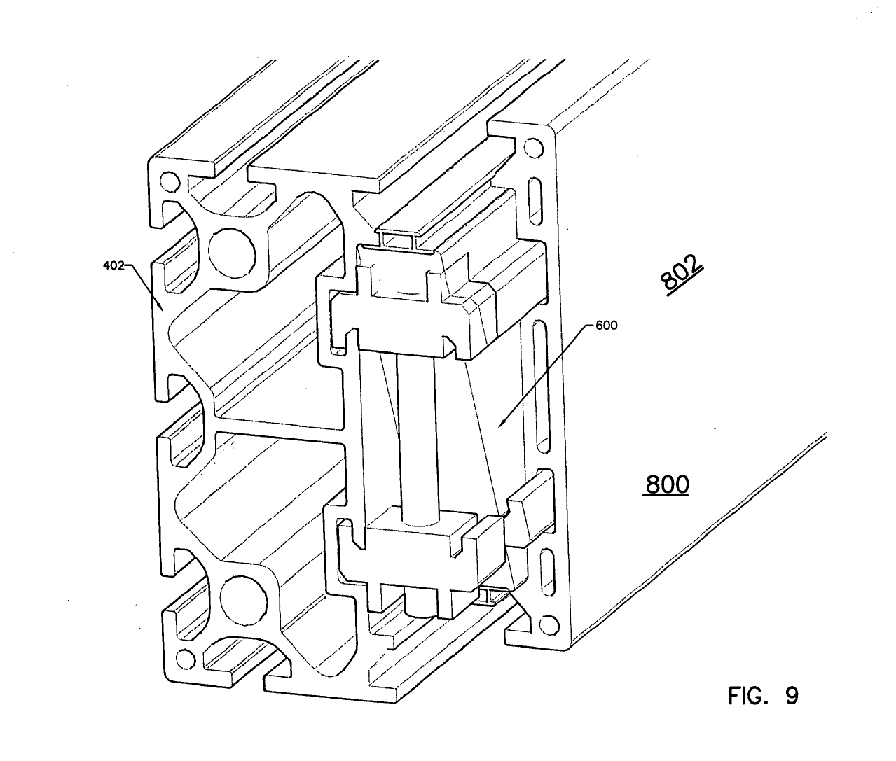

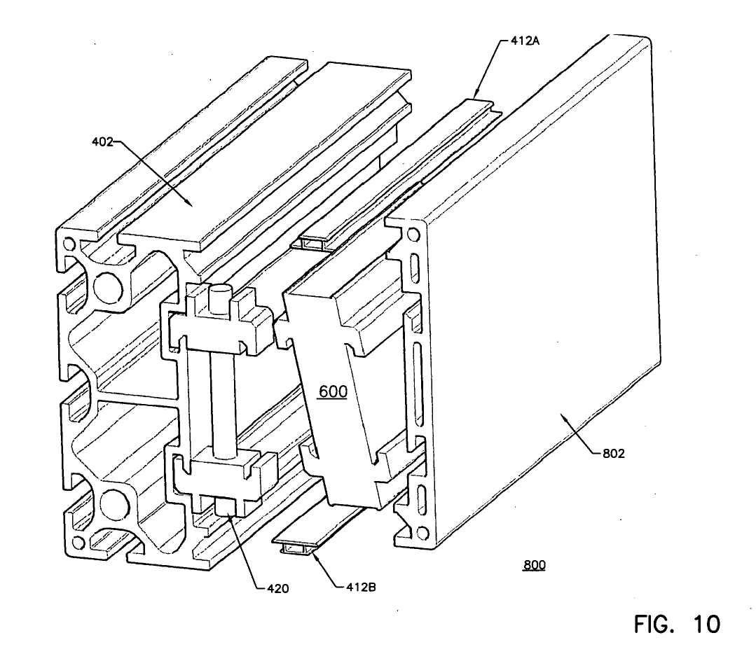

FIG. 9 shows an assembled, but unaligned view of the thermal insulating structural assembly of FIG. 8, where exemplary insulation 900 can be seen and is of the shape and size of the interior of the assembly 800. FIG. 10 is an exploded view of the assembly 800 of FIGS. 8 and 9.

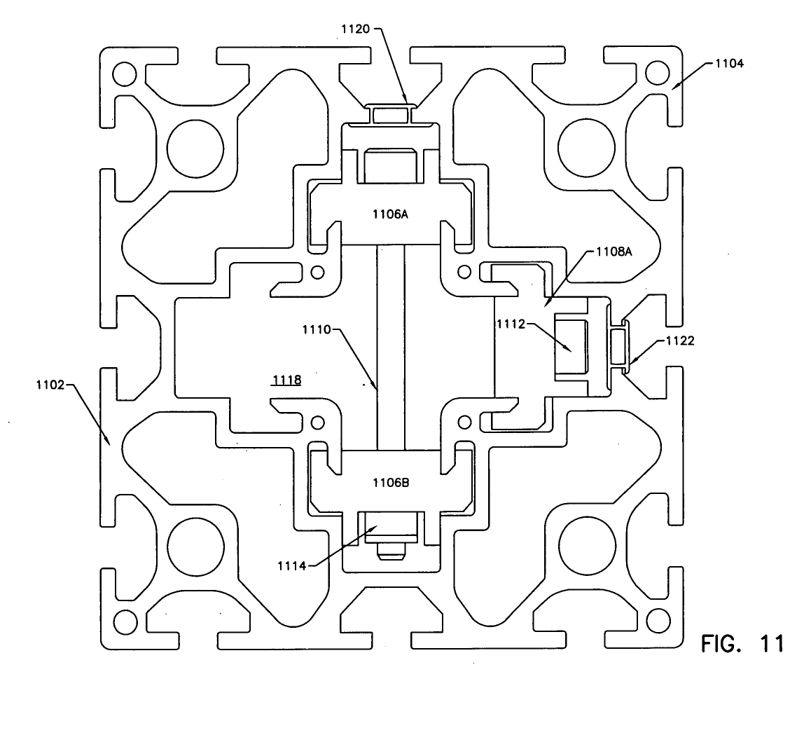

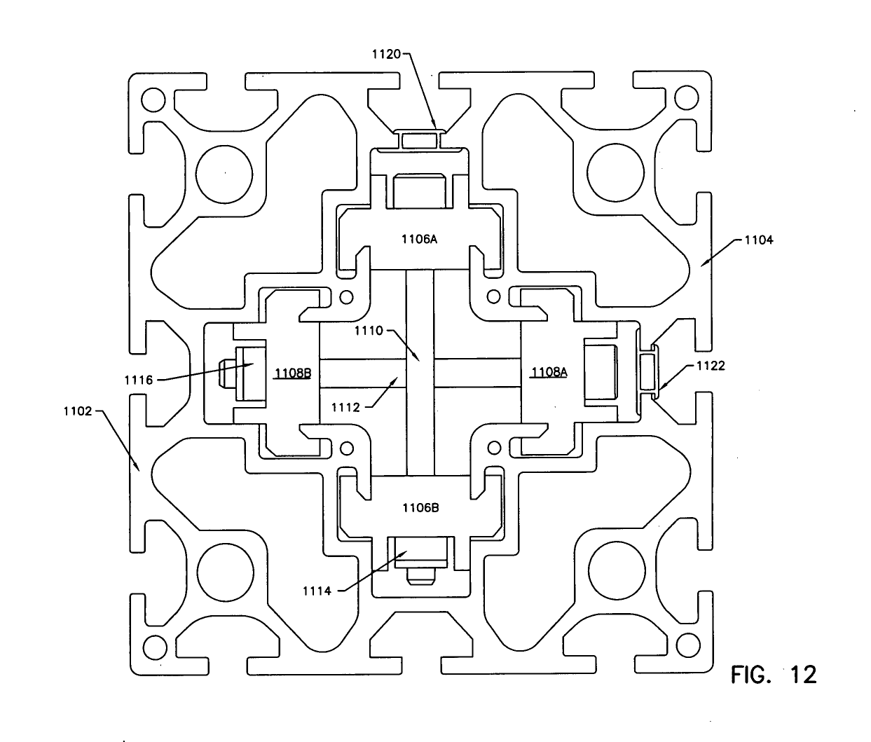

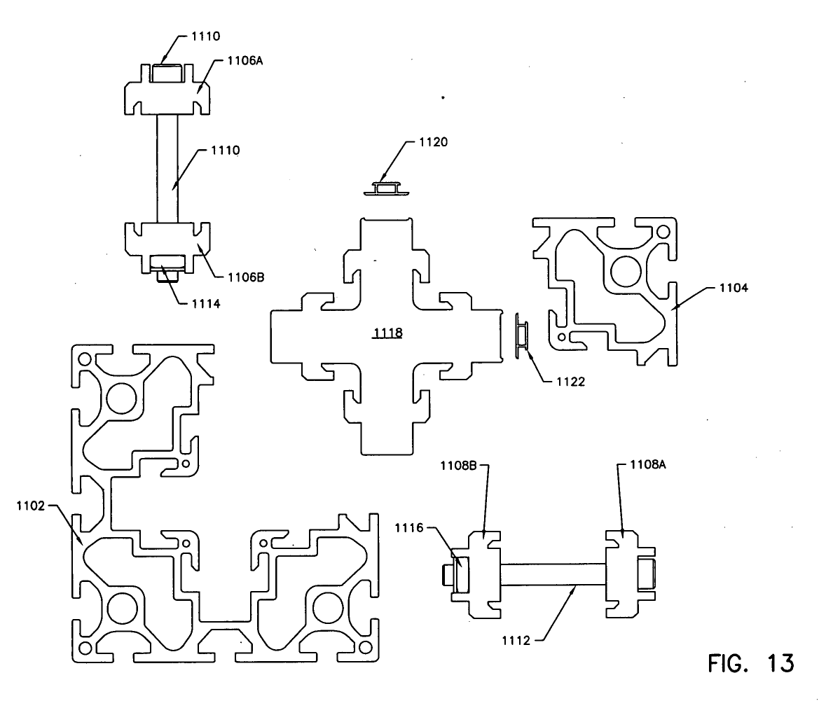

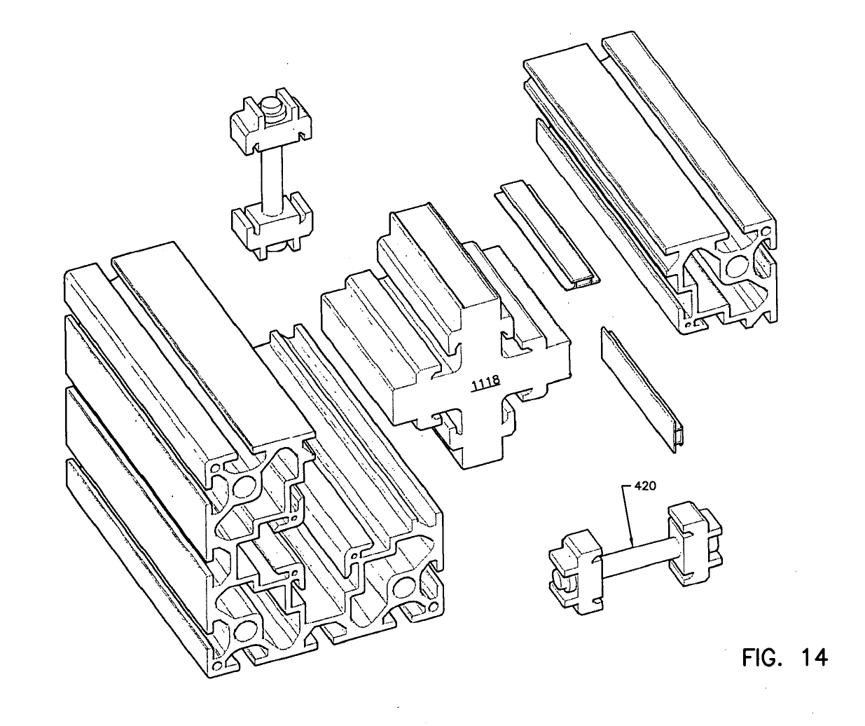

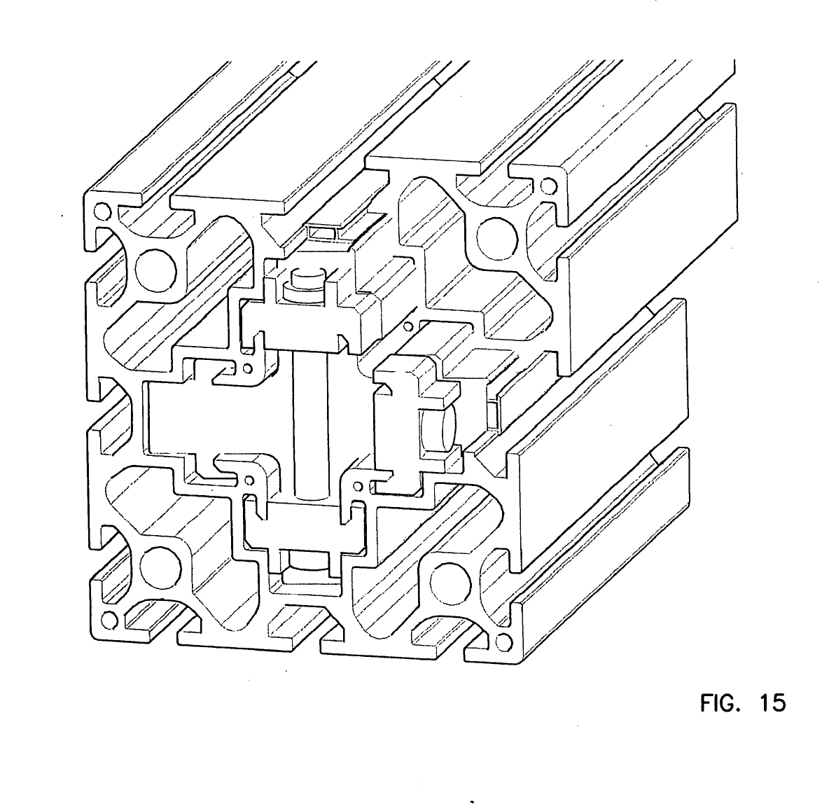

FIGS. 11-15 show an additional embodiment of the present invention, where a first beam 1102 and a second beam 1104 are joined by at least two sets of clamps 1106a, 1106b and 1108a, 1108b (shown in FIG. 12), each coupled together by a bolt 1110 and 1112, respectively, and a nut 1114 and 1116 (shown in FIG. 12), respectively. A set of spacers 1120 and 1122 separate the beams 1102 and 1104 and foam 1118 is provided in the interior of the beams 1102 and 1104.

The first beam 1102 provides three comers of a square and the coupled second beam 1104 provides the fourth corner. The embodiment shown in FIGS. 11-15 is merely exemplary. Other shapes, sizes, and configurations of beams, such as square or rectangular can be coupled as well and the invention is in no way limited to only that shown in the figures. The shape of the beam is determined by the load that beam will be responsible for. Non-load bearing walls or beams would allow us to use of a different strength and, therefore, a different width beam.

The invention is not limited to the particular clamp shown, or any particular material. In one embodiment, the clamp is not metal, yet, if metal clamps are small enough and/or spaced far enough apart, the resulting heat transfer (inside to/from outside) may be negligible. Non-metallic or coated metal clamps are also an available alternative.

In another embodiment for windows, clamps are used instead of the resin used in the prior art. Then, rather than milling the base of a channel, the channel is filled with insulation and closed off with the plastic strips to create a new beam with all the inherent properties of a single beam including full use of all T-slots.

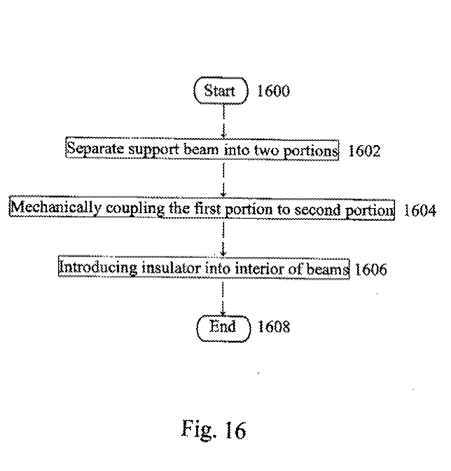

FIG. 16 shows an exemplary process flow diagram of a method for forming a thermal insulating structural assembly. The flow starts at step 1600 and progresses directly to step 1602, where an elongated metallic support beam is longitudinally separated into a first portion 402 and a second portion 404. The separation can be by sawing, laser cutting, or any other measures for separating a beam into two portions. In step 1604, the first beam portion 402 is mechanically coupled to the second beam portion 404 with a plurality of clamp assemblies 420 so that the first beam portion 402 is spaced a predetermined non-zero distance from the second beam portion 404 and is mechanically coupled to the second beam portion 404 only by the clamp assemblies 420. Next, in step 1606, a low thermal-conductive material (e.g., insulating foam) is introduced between the beam portions 402 and 404 that at least partially thermally insulates the first beam portion from the second beam portion. The flow ends in 1608.

### CONCLUSION

The inventive support structures, that have just been described, provide thermal insulation using inexpensive clamping assemblies to mechanically couple metallic structural beams. The structures advantageously have low material, processing, and installation costs and ensure quick and proper alignment during assembly. In addition, the components can easily by “mixed and matched.” For example, the outside beam can be swapped for one without T-slots. It is also possible to mate beams of varying profile dimensions and finishes.

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A thermal insulating structural assembly comprising:
a first and a second clamp assembly;
a first metallic beam;
a second metallic beam mechanically coupled to the first metallic beam by the first and second clamp assemblies so that the first metallic beam is spaced a predetermined non-zero distance from the second metallic beam; and
an insulating material provided between the first metallic beam and the second metallic beam, the material at least partially thermally isolating the first metallic beam from the second metallic beam.

2. The assembly according to claim 1, wherein each of the first and second clamp assemblies comprise:
a first beam coupling portion;
a second beam coupling portion opposing the first beam coupling portion; and
a coupling portion connecting member mechanically coupling the first beam coupling portion to the second beam coupling portion.

3. The clamp assembly according to claim 2, wherein each of the coupling portions comprise:
a pair of substantially parallel beam engaging areas spaced a predetermined non-zero distance from one another.

4. The assembly according to claim 1, wherein:
the first metallic beam and the second metallic beam are mirror symmetrical.

5. The assembly according to claim 1, wherein:
the first metallic beam forms three corners of a rectangle; and
the second metallic beam mates with the first metallic beam to complete the rectangle.

6. The assembly according to claim 5, wherein:
the first and second clamp assemblies are perpendicular to each other.

7. The assembly according to claim 1, wherein:
the first metallic beam defines a longitudinal cavity running the length of the beam.

8. The assembly according to claim 1, further comprising:
a first low-thermally conducting strip bridging the predetermined distance between the beams and defining together with the beams a structural-assembly interior therein.

9. The assembly according to claim 1, wherein:
the low thermal-conductive material is a hardened foam product.

10. A method of forming a thermal insulating structural assembly, the method comprising:
mechanically coupling a first metallic beam to a second metallic beam with a plurality of clamp assemblies so that the first metallic beam is spaced a predetermined non-zero distance from the second metallic beam and mechanically coupled only by the clamp assemblies; and
introducing between the beams an insulating material at least partially thermally isolating the first metallic beam from the second metallic beam.

11. The method according to claim 10, further comprising:
providing the beams as at least part of a structure with the first metallic beam facing an interior of the structure and the second metallic beam facing an exterior of the structure, thereby thermally insulating tile interior from the exterior.

12. The method according to claim 10, further comprising:
prior to the introducing step, inserting a pair of spacers between the beams, the spacers bridging the non-zero distance and defining, together with the beams, a structural-assembly interior therein.

13. The method according to claim 10, wherein each of the first and second clamp assemblies comprise:
a first beam coupling portion;
a second beam coupling portion opposing the first beam coupling portion; and
a coupling portion connecting member mechanically coupling the first beam coupling portion to the. second beam coupling portion.

14. The method assembly according to claim 13, wherein each of tile coupling portions comprise:
a pair of substantially parallel beam engaging areas spaced a predetermined non-zero distance from one another.

15. The method according to claim 10, wherein:
the first metallic beam and the second metallic beam are mirror symmetrical.

16. The method according to claim 10, further comprising:
forming at least one of the first metallic-beam and the second metallic beam by an extrusion process.

17. A method of forming a thermal insulating structural assembly, the method comprising:
longitudinally separating an elongated metallic support beam into a first portion and a second portion;
mechanically coupling the first beam portion to the second beam portion with a plurality of clamp assemblies so that the first beam portion is spaced a predetermined non-zero distance from the second beam portion and is mechanically coupled to the second beam portion only by the clamp assemblies; and
introducing between the beam portions, a thermally-insulating material at least partially thermally isolating the first beam portion from the second beam portion.

18. The method according to claim 17, further comprising:
providing the beams as at least part of a structure with the first metallic beam facing an interior of the structure and the second metallic beam facing an exterior of the structure, thereby thermally insulating the interior from the exterior.

19. The method according to claim 17, further comprising:
prior to the introducing step, inserting a pair of spacers between the beams, the spacers bridging the non-zero distance and defining together with the beams a structural-assembly interior therein.

20. The method according to claim 17, wherein each of the first and second clamp assemblies comprise:
a first beam coupling portion having a first pair of substantially parallel beam engaging areas spaced a predetermined non-zero distance from one another;
a second beam coupling portion opposing the first beam coupling portion and having a second pair of substantially parallel beam engaging areas spaced a predetermined non-zero distance from one another; and
a coupling portion connecting member mechanically coupling the first beam coupling portion to the second beam coupling portion.
